(19) United States
(12) Patent Application Publication
(10) Pub. No.: US 2020/0147950 A1
(43) Pub. Date: May 14, 2020

(54) A LITHOGRAPHIC PRINTING PLATE PRECURSOR

(71) Applicant: AGFA NV, Mortsel (BE)

(72) Inventor: Thomas BILLIET, Mortsel (BE)

(21) Appl. No.: 16/631,189

(22) PCT Filed: Jul. 5, 2018
(86) PCT No.: PCT/EP2018/068212

§ 371 Date: Jan. 15, 2020

(30) Foreign Application Priority Data
Jul. 20, 2017 (EP) 17182246.3

(51) Int. Cl. B41C 1/10; B41N 1/08

(52) U.S. Cl. CPC B41C 1/1008; B41C 2210/06; B41C 2210/04; B41N 1/08

(57) ABSTRACT

A lithographic printing plate precursor is disclosed including a support and a coating comprising a polymerisable compound, an initiator and an infrared absorbing dye wherein the initiator and the infrared absorbing dye are capable of inducing a print-out image.

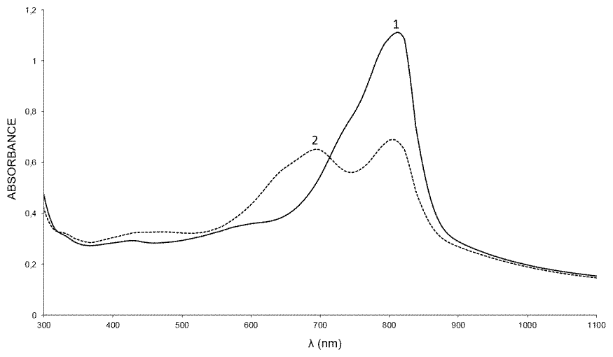

### CROSS REFERENCE TO RELATED APPLICATIONS

This application is a 371 National Stage Application of PCT/EP2018/068212, filed Jul. 5, 2018. This application claims the benefit of European Application No. 17182246.3, filed Jul. 20, 2017, which is incorporated by reference herein in its entirety.

### BACKGROUND OF THE INVENTION

### 1. Field of the Invention

The invention relates to a novel lithographic printing plate precursor.

### 2. Description of the Related Art

Lithographic printing typically involves the use of a so-called printing master such as a printing plate which is mounted on a cylinder of a rotary printing press. The master carries a lithographic image on its surface and a print is obtained by applying ink to said image and then transferring the ink from the master onto a receiver material, which is typically paper. In conventional lithographic printing, ink as well as an aqueous fountain solution (also called dampening liquid) are supplied to the lithographic image which consists of oleophilic (or hydrophobic, i.e. ink-accepting, water-repelling) areas as well as hydrophilic (or oleophobic, i.e. water-accepting, ink-repelling) areas. In so-called driographic printing, the lithographic image consists of ink-accepting and ink-abhesive (ink-repelling) areas and during driographic printing, only ink is supplied to the master.

Lithographic printing masters are generally obtained by the image-wise exposure and processing of a radiation sensitive layer on a lithographic support. Imaging and processing renders the so-called lithographic printing plate precursor into a printing plate or master. Image-wise exposure of the radiation sensitive coating to heat or light, typically by means of a digitally modulated exposure device such as a laser, triggers a (physico-)chemical process, such as ablation, polymerization, insolubilization by cross-linking of a polymer or by particle coagulation of a thermoplastic polymer latex, solubilization by the destruction of intermolecular interactions or by increasing the penetrability of a development barrier layer. Although some plate precursors are capable of producing a lithographic image immediately after exposure, the most popular lithographic plate precursors require wet processing since the exposure produces a difference in solubility or difference in rate of dissolution in a developer between the exposed and the non-exposed areas of the coating. In positive working lithographic plate precursors, the exposed areas of the coating dissolve in the developer while the non-exposed areas remain resistant to the developer. In negative working lithographic plate precursors, the non-exposed areas of the coating dissolve in the developer while the exposed areas remain resistant to the developer. Most lithographic plate precursors contain a hydrophobic coating on a hydrophilic support, so that the areas which remain resistant to the developer define the ink-accepting, hence printing areas of the plate while the hydrophilic support is revealed by the dissolution of the coating in the developer at the non-printing areas.

Photopolymer printing plates rely on a working-mechanism whereby the coating—which typically includes free radically polymerisable compounds—hardens upon exposure. “Hardens” means that the coating becomes insoluble or non-dispersible in the developing solution and may be achieved through polymerization and/or crosslinking of the photosensitive coating upon exposure to light. Photopolymer plate precursors can be sensitized to blue, green or red light i.e. wavelengths ranging between 450 and 750 nm, to violet light i.e. wavelengths ranging between 350 and 450 nm or to infrared light i.e. wavelengths ranging between 750 and 1500 nm. Optionally, the exposure step is followed by a heating step to enhance or to speed-up the polymerization and/or crosslinking reaction.

In general, a toplayer or protective overcoat layer over the imageable layer is required to act as an oxygen barrier to provide the desired sensitivity to the plate. A toplayer typically includes water-soluble or water-swellable polymers such as for example polyvinylalcohol. Besides acting as barrier for oxygen, the toplayer should best be easily removable during processing and be sufficiently transparent for actinic radiation, e.g. from 300 to 450 nm or from 450 to 750 nm or from 750 to 1500 nm.

The classical workflow of photopolymer plates involves first an exposure step of the photopolymer printing plate precursor in a violet or infrared platesetter, followed by an optional pre-heat step, a wash step of the protective overcoat layer, an alkaline developing step, and a rinse and gum step. Over the past years, there is a clear evolution in the direction of a simplified workflow where the pre-heat step and/or wash step are eliminated and where the processing and gumming step are carried out in one single step or where processing is carried out with a neutral gum and then gummed in a second step. Alternatively, on-press processing wherein the plate is mounted on the press and the coating layer is developed by interaction with the fountain and ink that are supplied to the plate during the press run, has become very popular. During the first runs of the press, the non-image areas are removed from the support and thereby define the non-printing areas of the plate.

In order to be able to evaluate the lithographic printing plates for image quality, such as for example image resolution and detail rendering (usually measured with an optical densitometer) before mounting them on the press, the lithographic printing plate precursors often contain a colorant such as a dye or a pigment in the coating. Such colorants provide, after processing, a contrast between the image areas containing the colorant and the hydrophilic support where the coating has been removed which enables the end-user to evaluate the image quality and/or to establish whether or not the precursor has been exposed to light. Furthermore, besides allowing for the evaluation of the image quality, a high contrast between the image and the hydrophilic support is required in order to obtain a good image registration (alignment) of the different printing plates in multi-colour printing in order to ensure image sharpness (resolution) and a correct rendering of the colours in the images present.

However, for photopolymer lithographic printing plates which are processed on-press and thus development of the plate is not carried out before mounting the plate on the press, a previous inspection and discrimination of the plate including colorants is not possible. A solution has been provided in the art by including components to the coating which are able to form upon exposure a so-called “print-out image”, i.e. an image which is visible before processing. In these materials however, often the photo-initiating system is a reacting component, which induces formation of the print-out image upon exposure, and therefore the lithographic differentiation may be reduced.

Formation of a print-out image for violet sensitized photopolymer systems have been disclosed in for example U.S. Pat. Nos. 3,359,109; 3,042,515; 4,258,123; 4,139,390; 5,141,839; 5,141,842; 4,232,106; 4,425,424; 5,030,548; 4,598,036; EP 434 968; WO 96/35143 and US 2003/68575.

The formation of a print-out image is also known for heat-sensitive photopolymer lithographic printing plates. Such plates are usually image-wise exposed by an IR-laser and often comprise, beside an IR dye as a light-to-heat conversion compound, also a dye which absorbs in the visible light wavelength range and changes colour upon heating. This colour change can be obtained for example with a heat-decomposable dye which bleaches upon heating such as disclosed in EP 897 134, EP 925 916, WO 96/35143, EP 1 300 241. Alternatively, this heat-induced colour change can be the result of a shift of the absorption maximum of a visible dye as disclosed in EP 1 502 736 and EP 419 095. A problem associated with these prior art materials where the print-out image is formed by a heat-induced reduction of the visible light absorption or by a switch from a highly colored to a weakly colored coating, is that the obtained print-out images are characterized by only a low contrast between the exposed and the non-exposed areas and/or high levels of dyes are required.

Thermochromic dye technology involves the design of an IR dye containing a thermocleavable group whereby a colour shift is obtained upon exposure with heat and/or light. This technology offers lithographic contrast which is enhanced by increasing either the thermochromic dye concentration or the exposure energy. However, this technology is especially suitable for thermofuse plates—i.e. plates including an image-recording layer that works by heat-induced particle coalescence of a thermoplastic polymer latex,—and does not work well in photopolymer coatings. Indeed, only an acceptable contrast in photopolymer coatings is feasible when exposed by very high laser energy and/or when a substantially high concentration of the thermochromic dye is incorporated in the coating.

EP 1 508 440 discloses a lithographic printing process wherein a printing plate precursor comprises an IR-dye and a dye-precursor having no substantial absorption in the visible light wavelength range but which upon image-wise exposure with IR-light, forms a dye having an absorption in the visible light wavelength range.

EP 1 428 676 discloses colour formation upon IR-light exposure by means of dye-precursors based on coalescence of a thermoplastic hydrophobic polymer particles that undergo discoloration by acid or radical formation during IR-light exposure. Often however, the obtained lithographic contrast is limited and/or high exposure energies are required, for example 300 mJ/m² or even more.

The heat-sensitive lithographic printing plate precursors disclosed in EP 925 916 include an IR dye which, upon IR-radiation, converts the IR-radiation into heat and at the same time changes in colour. In these prior art materials, the IR dyes exhibit, beside strong absorption in the IR wavelength range, also a side-absorption in the visible wavelength range. Due to IR-exposure, the IR dye decomposes and a print-out image is build-up by the reduction of this side-absorption in the visible wavelength range. However, print-out images with only a low contrast are obtained by these prior art materials.

Contrast-providing colorants obtained from the so-called leuco dyes that switch colour upon changes in pH, temperature, UV etc, have been widely used in the art. The leuco dye technology involves a switch between two chemical forms whereby one is colourless. If the colour switch is caused by for example pH or temperature, the transformation is reversible. Irreversible switches are based on redox reactions.

The use of contrast-providing colorants obtained from leuco dyes that become coloured in the presence of a thermal acid generator, is described for example, in U.S. Pat. Nos. 7,402,374; 7,425,406 and 7,462,440. The colouring of the printing areas is initiated by image-wise exposure whereby the image areas are visualized before performing development of the plate precursor. However, only a weak image contrast is obtained with this leuco dye technology and, moreover, high exposure energies are required to generate a contrast.

In conclusion, there is still a need for photopolymer plate coating formulations which offer an improved contrast between the image areas and background areas and which are preferably designed for direct on-press development, without causing the problems as discussed above.

### SUMMARY OF THE INVENTION

It is therefore an object of the present invention to provide a printing plate based on photopolymerisation which offers an excellent visual contrast upon imaging, even before processing.

This object is realised by the printing plate precursor defined below with preferred embodiments also defined below. The invention has the specific feature that the printing plate material includes a coating comprising a trihaloalkyl sulfone initiator and an infrared absorbing agent, without the presence of substantially any colorant. A colorant is a dye or a pigment preferably having an absorption maximum equal to or below 780 nm, more preferably between 390 and 750 nm and most preferably between 390 and 700 nm. The coating used in the present invention does substantially exclude the presence of such colorants or, in other words, is substantially colorant-free. The word “substantially” means that the presence of unavoidable impurities and/or very small amounts of colorants which might have been added to the coating, are tolerated. Very small amounts refer to for example less than 1% wt, preferably less than 0.5% wt and most preferably less than 0.1% wt, based on the total weight of the coating. A colorant is a compound which is visible for the human eye, typically the portion of the electromagnetic spectrum that is visible to the human eye are wavelengths from about 390 to 780 nm.

It has surprisingly been observed that upon heat and/or light exposure of the coating according to the present invention, a print-out image is formed without the presence of any additional components such as for example a colorant. It is believed that the working mechanism may be based on a redox reaction whereby the IR absorbing agent oxidizes in the presence of the trihaloalkyl sulfone initiator upon imaging. Thus the initiator and IR absorbing agent fullfill two roles at the same time: i.e. functional components for (i) the photopolymerization, and for (ii) contrast generation. Moreover, it has been surprisingly found that the contrast may be generated at low exposure energy levels; for example below 150 mJ/m², even far below 120 mJ/m².

It is a further object of the present invention to provide a method for making a lithographic printing plate comprising the steps of:

image-wise exposing the printing plate precursor including the coating as defined above to heat and/or IR radiation whereby a lithographic image consisting of image areas and non-image areas is formed and whereby a colour change in the image areas is induced;

developing the exposed precursor.

The CIE 1976 colour distance ΔE measured before development and after exposure, for example with an energy density between 70 and 150 mJ/m², more preferably between 75 and 120 mJ/m², most preferably of maximum 80 mJ/m², between the exposed and non-exposed areas preferably has a value of at least 3.

The development is preferably carried out by treating the precursor with a gum solution, however more preferably by mounting the precursor on a plate cylinder of a lithographic printing press and rotating the plate cylinder while feeding dampening liquid and/or ink to the precursor.

Other features, elements, steps, characteristics and advantages of the present invention will become more apparent from the following detailed description of preferred embodiments of the present invention. Specific embodiments of the invention are also defined below.

### BRIEF DESCRIPTION OF THE DRAWINGS

The FIGURE shows a UV-visible absorption spectrum of a coating comprising an IR absorbing agent and a TBM-initiator.

### DETAILED DESCRIPTION OF THE PREFERRED EMBODIMENTS

The lithographic printing plate precursor of the current invention comprises an infrared absorbing agent and a trihaloalkyl sulfone initiator, further also referred to as “TBM-initiator”. The infrared absorbing agent has no substantial absorption in the visible light wavelength range and is thus colourless or pale-coloured. The infrared absorbing agent preferably has an absorption maximum above 780 nm up to 1500 nm. It was surprisingly found that infrared absorbing agents which are colourless or pale-coloured change into a coloured compound when exposed to heat and/or light in the presence of a TBM-initiator, or, in other words, it was found that a coating comprising an IR absorbing agent and a TBM-initiator forms a clear print-out image upon exposure to heat and/or light. It is believed that upon exposure, a redox reaction occurs whereby a colored, oxidized compound is obtained. This invention is of specific interest as the presence of a colorant such as for example a dye, a pigment or a dye precursor is redundant and consequently favorable, not only from an economical point of view, but also eliminates the risk of staining of equipment and/or processing fluids. Furthermore, as the colour change is obtained immediately after the exposure step and thus a print-out image is formed, the plate is specifically suited for development on-press i.e. development by mounting the precursor on a plate cylinder of a lithographic printing press and rotating the plate cylinder while feeding dampening liquid and/or ink to the coating. Moreover, the exposure energy required to obtain a print-out image is low compared to the systems provided in the art, for example below 150 mJ/m², even far below 120 mJ/m²; a clear print-out image is already obtained at energy levels of about 80 to 100 mJ/m². In addition, the print-out image is already obtained at a low concentration of IR dye; for example at an amount of 0.1% wt to 3% wt.

The colour difference between the exposed and non-exposed areas of the coating calculated from the L*a*b* values of the exposed areas of the image areas (exposed areas) of the coating and the L*a*b* values of non-image areas (non-exposed areas) of the coating, is denoted as ΔE. It has surprisingly been found that upon exposure of the coating of the present invention with a low energy density, for example between 70 and 150 mJ/m², more preferably between 75 and 120 mJ/m², most preferably of maximum 80 mJ/m², a print-out image is formed characterised by a CIE 1976 colour difference ΔE of at least 3, more preferably at least 3.5 and most preferably at least 4. ΔE is the CIE 1976 colour distance Delta E that is defined by the pair wise Euclidean distance of the CIE L*a*b* colour coordinates. CIE L*a*b* colour coordinates are obtained from reflection measurement in 45/0 geometry (non-polarized), using CIE 2° observer and D50 as illuminant. More details are described in CIE S 014-4/E: 2007 Colourimetry—Part 4: CIE 1976 L*a*b* Colour Spaces and CIE publications and CIE S 014-1/E:2006, CIE Standard Colourimetric Observers.

The CIE 1976 colour coordinates L*, a* and b* discussed herein are part of the well-known CIE (Commission Internationale de l'Eclairage) system of tristimulus colour coordinates, which also includes the additional chroma value C* defined as C*=[(a)²+(b)²]^{1/2}. The CIE 1976 colour system is described in e.g. “Colorimetry, CIE 116-1995: Industrial Colour Difference Evaluation”, or in “Measuring Colour” by R. W. G. Hunt, second edition, edited in 1992 by Ellis Horwood Limited, England.

CIE L*a*b* values discussed and reported herein have been measured following the ASTM E308-85 method.

The invention is clearly illustrated in the FIGURE: a UV-visible absorption spectrum of a coating comprising an IR absorbing agent and a TBM-initiator which shows a maximum absorption (1) in the IR-wavelength range which, upon exposure, is reduced and a second absorption peak (2) is formed in the visual-wavelength range. Thus, at the exposed areas of the coating—including an IR absorbing agent and the TBM-initiator—the L*, and b* coordinates are enhanced due to absorption in the visual wavelength range whereby a clear print-out image is formed.

The print-out image is visible due to the contrast of the image which is defined as the colour difference between the exposed areas and the non-exposed areas. This contrast is preferably as high as possible and enables the end-user to establish immediately after imaging whether or not the precursor has already been exposed to heat and/or light, to distinguish the different colour selections and to inspect the quality of the image on the plate precursor.

### The Initiator

The TBM-initiator is a compound capable of generating free radicals upon exposure, optionally in the presence of a sensitizer. The TBM-initiator is an optionally substituted trihaloalkyl sulfone compound wherein halo independently represents bromo, chloro or iodo and sulfone is a chemical compound containing a sulfonyl functional group attached to two carbon atoms.

The TBM-initiator is an optionally substituted trihaloalkyl aryl or heteroaryl sulfone compound. The optionally substituted aryl is preferably an optionally substituted phenyl, benzyl, tolyl or an ortho- meta- or para-xylyl, naphtyl, anthracenyl, phenanthrenyl, and/or combinations thereof. The heteroaryl group is preferably a monocyclic or polycyclic aromatic ring comprising carbon atoms and one or more heteroatoms in the ring structure, preferably, 1 to 4 heteroatoms, independently selected from nitrogen, oxygen, selenium and sulphur. Preferred examples thereof include an optionally substituted furyl, pyridinyl, pyrimidyl, pyrazoyl, imidazoyl, oxazoyl, isoxazoyl, thienyl, tetrazoyl, thiazoyl, (1,2,3)triazoyl, (1,2,4)triazoyl, thiadiazoyl, thiofenyl group and/or combinations thereof.and the optionally substituted heteroaryl is preferably a five- or six-membered ring substituted by one, two or three oxygen atoms, nitrogen atoms, sulphur atoms, selenium atoms or combinations thereof. Examples thereof include furan, thiophene, pyrrole, pyrazole, imidazole, 1,2,3-triazole, 1,2,4-triazole, tetrazole, oxazole, isoxazole, triazole, isothiazole, thiadiazole, oxadiazole, pyridine, pyridazine, pyrimidine, pyrazine, 1,3,5-triazine, 1,2,4-triazine or 1,2,3-triazine, benzofuran, benzothiophene, indole, indazole, benzoxazole, quinoline, quinazoline, benzimidazole or benztriazole.

Preferably the TBM-initiator is an optionally substituted trihalomethyl aryl sulfone; more preferably a tribromomethyl aryl sulfone, most preferably the TBM-initiator is an optionally substituted tribromomethyl phenyl sulfone.

The term “alkyl” herein means all variants possible for each number of carbon atoms in the alkyl group i.e. methyl, ethyl, for three carbon atoms: n-propyl and isopropyl; for four carbon atoms: n-butyl, isobutyl and tertiary-butyl; for five carbon atoms: n-pentyl, 1,1-dimethyl-propyl, 2,2-dimethylpropyl and 2-methyl-butyl, etc. Preferably, the alkyl group is preferably a C₁ to C₆-alkyl group. Most preferably the alkyl is a methyl group.

The term “substituted”, in e.g. substituted alkyl group means that the alkyl group may be substituted by other atoms than the atoms normally present in such a group, i.e. carbon and hydrogen. For example, a substituted alkyl group may include a halogen atom or a thiol group. An unsubstituted alkyl group contains only carbon and hydrogen atoms.

The optional substituents represent an alkyl, cycloalkyl, alkenyl or cyclo alkenyl group, an alkynyl group, an aryl or heteroaryl group, an alkylaryl or arylalkyl group, an alkoxy or aryloxy group, a thio alkyl, thio aryl or thio heteroaryl group, a hydroxyl group, —SH, a carboxylic acid group or an alkyl ester thereof, a sulphonic acid group or an alkyl ester thereof, a phosphonic acid group or an alkyl ester thereof, a phosphoric acid group or an alkyl ester thereof, an amino group, a sulphonamide group, an amide group, a nitro group, a nitrile group, a halogen, or a combination thereof.

A suitable alkenyl group is preferably a C₂ to C₆-alkenyl group such as an ethenyl, n-propenyl, n-butenyl, n-pentenyl, n-hexenyl, iso-propenyl, iso-butenyl, iso-pentenyl, neo-pentenyl, 1-methylbutenyl, iso-hexenyl, cyclopentenyl, cyclohexenyl and methylcyclohexenyl group.

A suitable alkynyl group is preferably a C₂ to C₆-alkynyl group; a suitable aralkyl group is preferably a phenyl group or naphthyl group including one, two, three or more C₁ to C₆-alkyl groups; a suitable alkaryl group is preferably a C₁ to C₆-alkyl group including an aryl group, preferably a phenyl group or naphthyl group.

A cyclic group or cyclic structure includes at least one ring structure and may be a monocyclic- or polycyclic group, meaning one or more rings fused together.

The amount of the TBM-initiator typically ranges from 0.1 to 30% by weight, preferably from 0.5 to 10% by weight, most preferably from 2 to 7% by weight relative to the total weight of the non volatile components of the photopolymerisable composition.

### The Infrared Absorbing Compound

The IR absorbing compound present in the coating is preferably an infrared absorbing dye also referred to as IR dye. The infrared absorbing dyes preferably have an absorption maximum above 780 nm up to 1500 nm. Particular preferred dyes are cyanine, merocyanine, indoaniline, oxonol, pyrilium and squarilium dyes. Most preferred are heptamethinecyane dyes. Examples of suitable IR dyes may be found in EP 1 359 008 paragraph [0030] to [0032] including the references cited therein. Other suitable sensitizers are disclosed in U.S. Pat. Nos. 6,410,205, 5,049,479, EP 1 079 276, EP 1 369 232, EP 1 369 231, EP 1 341 040, US 2003/0124460, EP 1 241 002 and EP 1 288 720.

The infrared dye does not have a substantial light absorption in the visible wavelength range i.e. a wavelength range between 390 and 780 nm.

The concentration of the IR-dyes with respect to the total dry weight of the coating, may be from 0.1 wt. % to 20.0 wt. %, more preferably from 0.5% wt to 15.0% wt, most preferred from 1.0 wt % to 10.0 wt %. According to the present invention, the amount of the infrared dye is preferably from 0.1 to 3% wt, more preferably from 0.2 to 1.5% wt and most preferably from 0.5 to 1% wt.

The infrared absorbing agent is preferably represented by Formula I:

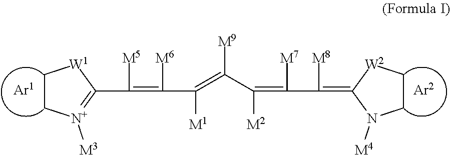

wherein
Ar¹ and Ar² are independently an optionally substituted aryl group or an aryl group with an annulated benzene ring which is optionally substituted,
W1 and W2 are independently a sulphur atom or a —CM10M11 group wherein M10 and M11 are independently an optionally substituted aliphatic hydrocarbon group or an optionally substituted (hetero)aryl group, or wherein M10 and M11 together comprise the necessary atoms to form a cyclic structure,
M1 and M2 together comprise the necessary atoms to form an optionally substituted cyclic structure, preferably M1 and M2 together comprise the necessary atoms to form an optionally substituted 5-membered ring,
M3 and M4 independently represent an optionally substituted aliphatic hydrocarbon group,
M5, M6, M7 and M8 independently represent hydrogen, a halogen or an optionally substituted aliphatic hydrocarbon group,
M9 represents a halogen, an optionally substituted aliphatic hydrocarbon group, an optionally substituted (hetero)aryl group, —NR1R2, —NR1-CO—R6, —NR1-SO2-R4 or —NR1-SO—R5; wherein
R1 and R2 independently represent hydrogen, an optionally substituted aliphatic hydrocarbon group or an optionally substituted (hetero)aryl group;
R4 and R6 independently represent —OR7, —NR8R9 or —CF3; wherein
R7 represents an optionally substituted (hetero)aryl group or an optionally branched aliphatic hydrocarbon group and R8 and R9 independently represent hydrogen, an optionally substituted aliphatic hydrocarbon group or an optionally substituted (hetero)aryl group, or wherein R8 and R9 together comprise the necessary atoms to form a cyclic structure;
R5 represents hydrogen, an optionally substituted aliphatic hydrocarbon group, SO3-, —COOR10 or an optionally substituted (hetero)aryl group; wherein R10 represents an optionally substituted (hetero)aryl group or an aliphatic hydrocarbon group; and
the infrared absorbing agent may include one or more counter ions in order to obtain an electrically neutral molecule.

An aliphatic hydrocarbon group preferably represents an alkyl, cycloalkyl, alkenyl, cyclo alkenyl or alkynyl group; suitable groups thereof are described above. Suitable hetero(aryl) groups—i.e. suitable aryl or heteroaryl groups—are described above.

Suitable examples of optional substituents are described above.

The IR dye can be a neutral, an anionic or a cationic dye depending on the type of the substituting groups and the number of each of the substituting groups. The dye may have one anionic or acid group, selected from —CO₂H, —CONHSO₂R^{h}, —SO₂NHCORⁱ, —SO₂NHSO₂R^{j}, —PO₃H₂, —OPO₃H₂, —OSO₃H, —S—SO₃H or —SO₃H groups or their corresponding salts, wherein R^{h}, Rⁱ and R^{j} independently represent an aryl or an alkyl group, preferably a methyl group, and wherein the salts are preferably alkali metal salts or ammonium salts, including mono- or di- or tri- or tetra-alkyl ammonium salts.

The IR-dye is preferably presented by one of the following formulae II to VI:

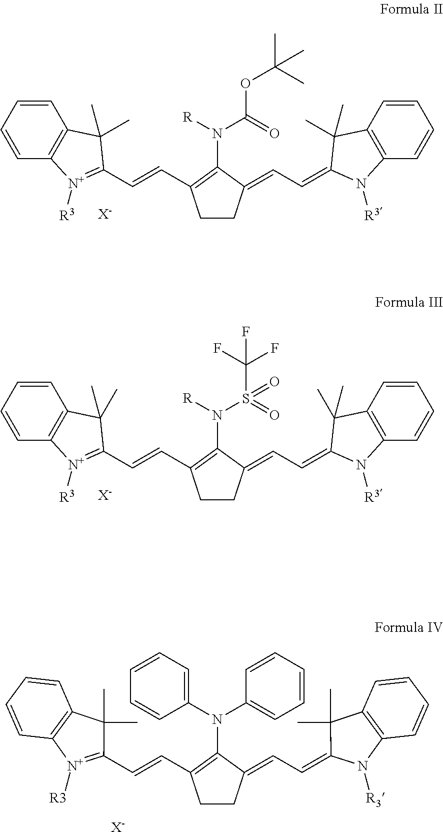

wherein
X⁻ represents halogen, sulphonate, perfluorosulphonate, tosylate, tetrafluoroborate, hexafluorophosphate, arylborate or arylsulphonate; and
R³, R^{3′} independently represent an optionally substituted alkyl group, preferably a methyl or ethyl; or an ether group, preferably —CH₂—CH₂—O—CH₃.

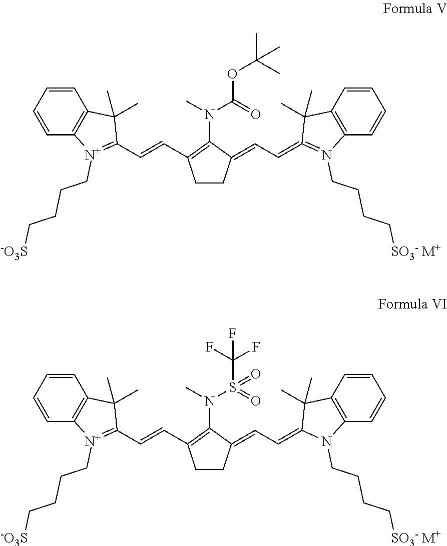

wherein
M⁺=Li⁺, Na⁺, K⁺, NH₄⁺, R′R″R′″NH⁺ wherein R′, R″, R′″ are independently a H atom, an optional substituted alkyl or aryl group.

### The Lithographic Printing Plate Precursor

The lithographic printing plate precursor according to the present invention is negative-working, i.e. after exposure and development the non-exposed areas of the coating are removed from the support and define hydrophilic (non-printing) areas, whereas the exposed coating is not removed from the support and defines oleophilic (printing) areas. The hydrophilic areas are defined by the support which has a hydrophilic surface or is provided with a hydrophilic layer. The hydrophobic areas are defined by the coating, hardened upon exposing, optionally followed by a heating step. Areas having hydrophilic properties means areas having a higher affinity for an aqueous solution than for an oleophilic ink; areas having hydrophobic properties means areas having a higher affinity for an oleophilic ink than for an aqueous solution.

“Hardened” means that the coating becomes insoluble or non-dispersible for the developing solution and may be achieved through polymerization and/or crosslinking of the photosensitive coating, optionally followed by a heating step to enhance or to speed-up the polymerization and/or crosslinking reaction. In this optional heating step, hereinafter also referred to as “pre-heat”, the plate precursor is heated, preferably at a temperature of about 80° C. to 150° C. and preferably during a dwell time of about 5 seconds to 1 minute.

The coating has at least one layer including a photopolymerisable composition, said layer is also referred to as the “photopolymerisable layer”. The coating may include an intermediate layer, located between the support and the photopolymerisable layer. The lithographic printing precursors can be multi-layer imageable elements.

The printing plate of the present invention is characterized that it can be exposed at a low energy density, i.e. below 190 mJ/m²; preferably between 70 mJ/m² and 150 mJ/m²; more preferably between 75 mJ/m² and 120 mJ/m² and most preferably of maximum 80 mJ/m².

### Support

The lithographic printing plate used in the present invention comprises a support which has a hydrophilic surface or which is provided with a hydrophilic layer. The support is preferably a grained and anodized aluminium support, well known in the art. Suitable supports are for example disclosed in EP 1 843 203 (paragraphs [0066] to [0075]). The surface roughness, obtained after the graining step, is often expressed as arithmetical mean center-line roughness Ra (ISO 4287/1 or DIN 4762) and may vary between 0.05 and 1.5 μm. The aluminum substrate of the current invention has preferably an Ra value below 0.45 μm, more preferably below 0.40 μm and most preferably below 0.30 μm. The lower limit of the Ra value is preferably about 0.1 μm. More details concerning the preferred Ra values of the surface of the grained and anodized aluminum support are described in EP 1 356 926. By anodising the aluminum support, an Al₂O₃ layer is formed and the anodic weight (g/m² Al₂O₃ formed on the aluminum surface) varies between 1 and 8 g/m². The anodic weight is preferably ≥3 g/m², more preferably 3.5 g/m² and most preferably ≥4.0 g/m².

The grained and anodized aluminium support may be subjected to so-called post-anodic treatments, for example a treatment with polyvinylphosphonic acid or derivatives thereof, a treatment with polyacrylic acid, a treatment with potassium fluorozirconate or a phosphate, a treatment with an alkali metal silicate, or combinations thereof. Alternatively, the support may be treated with an adhesion promoting compound such as those described in EP 1 788 434 in [0010] and in WO 2013/182328. However, for a precursor optimized to be used without a pre-heat step it is preferred to use a grained and anodized aluminium support without any post-anodic treatment.

Besides an aluminium support, a plastic support, for example a polyester support, provided with one or more hydrophilic layers as disclosed in for example EP 1 025 992 may also be used.

### Photopolymer Coating

The coating has at least one layer including a photopolymerisable composition, said layer is also referred to as the “photopolymerisable layer”. The coating may include an intermediate layer, located between the support and the photopolymerisable layer.

The photopolymerisable layer includes besides the TBM-initiator and the infrared absorbing compound as discussed above, a polymerisable compound and optionally a binder. The photopolymerisable layer has a coating thickness preferably ranging between 0.2 and 5.0 g/m², more preferably between 0.4 and 3.0 g/m², most preferably between 0.6 and 2.2 g/m².

According to a preferred embodiment of the present invention, the polymerisable compound is a polymerisable monomer or oligomer including at least one terminal ethylenic group, hereinafter also referred to as “free-radical polymerisable monomer”. The polymerisation involves the linking together of the free-radical polymerisable monomers.

Suitable free-radical polymerisable monomers are disclosed in [0042] and [0050] of EP 2 916 171 and are incorporated herein by reference.

Besides the TBM-initiator, the coating may optionally further contain any free radical initiator capable of generating free radicals upon exposure directly or in the presence of a sensitizer. Suitable free-radical initiators are described in WO 2005/111727 from page 15 line 17 to page 16 line 11 and EP 1 091 247 and may include for example hexaaryl-bisimidazole compound (HABI; dimer of triaryl-imidazole), aromatic ketones, aromatic onium salts, organic peroxides, thio compounds, ketooxime ester compounds, borate compounds, azinium compounds, metallocene compounds, active ester compounds and further compounds having a carbon-halogen bond.

The photopolymerisable layer may also comprise a co-initiator. Typically, a co-initiator is used in combination with a free radical initiator. Suitable co-initiators for use in the photopolymer coating are disclosed in U.S. Pat. Nos. 6,410,205; 5,049,479; EP 1 079 276, EP 1 369 232, EP 1 369 231, EP 1 341 040, US 2003/0124460, EP 1 241 002, EP 1 288 720 and in the reference book including the cited refences: Chemistry & Technology UV & EB formulation for coatings, inks & paints—Volume 3—Photoinitiators for Free Radical and Cationic Polymerisation by K. K. Dietliker—Edited by P. K. T. Oldring—1991—ISBN 0 947798161. Specific co-initiators, as described in EP 107 792, may be present in the photopolymerizable layer to further increase the sensitivity. Preferred co-initiators are disclosed in EP 2 916 171 [0051] and are incorporated herein by reference.

A very high sensitivity can be obtained by including a sensitizer such as for example an optical brightener in the coating. Suitable examples of optical brighteners as sensitizers are described in WO 2005/109103 page 24, line 20 to page 39. Other preferred sensitizers are blue, green or red light absorbing sensitizers, having an absorption spectrum between 450 nm and 750 nm. Useful sensitizers can be selected from the sensitizing dyes disclosed in U.S. Pat. Nos. 6,410,205; 5,049,479; EP 1 079 276, EP 1 369 232, EP 1 369 231, EP 1 341 040, US 2003/0124460, EP 1 241 002 and EP 1 288 720.

The photopolymerizable layer preferably includes a binder. The binder can be selected from a wide series of organic polymers. Compositions of different binders can also be used. Useful binders are described in WO2005/111727 page 17 line 21 to page 19 line 30, EP 1 043 627 in paragraph [0013] and in WO2005/029187 page 16 line 26 to page 18 line 11.

The photopolymerizable layer may also comprise particles which increase the resistance of the coating against manual or mechanical damage. The particles may be inorganic particles, organic particles or fillers such as described in for example U.S. Pat. No. 7,108,956. More details of suitable spacer particles described in EP 2 916 171 [0053] to [0056] are incorporated herein by reference.

The photopolymerizable layer may also comprise an inhibitor. Particular inhibitors for use in the photopolymer coating are disclosed in U.S. Pat. No. 6,410,205, EP 1 288 720 and EP 1 749 240.

The photopolymerizable layer may further comprise an adhesion promoting compound. The adhesion promoting compound is a compound capable of interacting with the support, preferably a compound having an addition-polymerizable ethylenically unsaturated bond and a functional group capable of interacting with the support. Under “interacting” is understood each type of physical and/or chemical reaction or process whereby, between the functional group and the support, a bond is formed which can be a covalent bond, an ionic bond, a complex bond, a coordinate bond or a hydrogen-bond, and which can be formed by an adsorption process, a chemical reaction, an acid-base reaction, a complex-forming reaction or a reaction of a chelating group or a ligand. The adhesion promoting compounds described in EP 2 916 171 [0058] are incorporated herein by reference.

Various surfactants may be added into the photopolymerisable layer to allow or enhance the developability of the precursor; especially developing with a gum solution. Both polymeric and small molecule surfactants for example nonionic surfactants are preferred. More details are described in EP 2 916 171 [0059] and are incorporated herein by reference.

The coating may include on the photopolymerisable layer, a toplayer or protective overcoat layer which acts as an oxygen barrier layer including water-soluble or water-swellable binders. Printing plate precursors which do not contain a toplayer or protective overcoat layer are also referred to as overcoat-free printing plate precursors. In the art, it is well-known that low molecular weight substances present in the air may deteriorate or even inhibit image formation and therefore usually a toplayer is applied to the coating. A toplayer should be easily removable during development, adhere sufficiently to the photopolymerisable layer or optional other layers of the coating and should preferably not inhibit the transmission of light during exposure. Preferred binders which can be used in the toplayer are polyvinyl alcohol and the polymers disclosed in WO 2005/029190; U.S. Pat. No. 6,410,205 and EP 1 288 720, including the cited references in these patents and patent applications. The most preferred binder for the toplayer is polyvinylalcohol. The polyvinylalcohol has preferably a hydrolysis degree ranging between 74 mol % and 99 mol %, more preferably between 88-98%. The weight average molecular weight of the polyvinylalcohol can be measured by the viscosity of an aqueous solution, 4% by weight, at 20° C. as defined in DIN 53 015, and this viscosity number ranges preferably between 2 and 26, more preferably between 2 and 15, most preferably between 2 and 10.

The overcoat layer may optionally include other ingredients such as inorganic or organic acids, matting agents or wetting agents as disclosed in EP 2 916 171 and are incorporated herein by reference.

The coating thickness of the optional toplayer is preferably between 0.25 and 1.75 g/m², more preferably between 0.25 and 1.3 g/m², most preferably between 0.25 and 1.0 g/m². In a more preferred embodiment of the present invention, the optional toplayer has a coating thickness between 0.25 and 1.75 g/m² and comprises a polyvinylalcohol having a hydrolysis degree ranging between 74 mol % and 99 mol % and a viscosity number as defined above ranging between 3 and 26.

According to the present invention there is also provided a method for making a negative-working lithographic printing plate comprising the steps of imagewise exposing a printing plate precursor followed by developing the imagewise exposed precursor so that the non-exposed areas are dissolved in the developer solution. Optionally, after the imaging step, a heating step is carried out to enhance or to speed-up the polymerization and/or crosslinking reaction. The lithographic printing plate precursor can be prepared by (i) applying on a support the coating as described above and (ii) drying the precursor.

### Exposure Step

The printing plate precursor is preferably image-wise exposed by a laser emitting IR-light. Preferably, the image-wise exposing step is carried out off-press in a platesetter, i.e. an exposure apparatus suitable for image-wise exposing the precursor with a laser such as a laser diode, emitting around 830 nm or a Nd YAG laser emitting around 1060 nm, or by a conventional exposure in contact with a mask. In a preferred embodiment of the present invention, the precursor is image-wise exposed by a laser emitting IR-light.

### Preheat Step

After the exposing step, the precursor may be pre-heated in a preheating unit, preferably at a temperature of about 80° C. to 150° C. and preferably during a dwell time of about 5 seconds to 1 minute. This preheating unit may comprise a heating element, preferably an IR-lamp, an UV-lamp, heated air or a heated roll. Such a preheat step can be used for printing plate precursors comprising a photopolymerisable composition to enhance or to speed-up the polymerization and/or crosslinking reaction.

### Development Step

Subsequently to the exposing step or the preheat step, when a preheat step is present, the plate precursor may be processed (developed). Before developing the imaged precursor, a pre-rinse step might be carried out especially for the negative-working lithographic printing precursors having a protective oxygen barrier or topcoat. This pre-rinse step can be carried out in a stand-alone apparatus or by manually rinsing the imaged precursor with water or the pre-rinse step can be carried out in a washing unit that is integrated in a processor used for developing the imaged precursor. The washing liquid is preferably water, more preferably tap water. More details concerning the wash step are described in EP 1 788 434 in [0026].

During the development step, the non-exposed areas of the image-recording layer are at least partially removed without essentially removing the exposed areas. The processing liquid, also referred to as developer, can be applied to the plate e.g. by rubbing with an impregnated pad, by dipping, immersing, coating, spincoating, spraying, pouring-on, either by hand or in an automatic processing apparatus. The treatment with a processing liquid may be combined with mechanical rubbing, e.g. by a rotating brush. During the development step, any water-soluble protective layer present is preferably also removed. The development is preferably carried out at temperatures between 20 and 40° C. in automated processing units.

In a highly preferred embodiment, the processing step as described above is replaced by an on-press processing whereby the imaged precursor is mounted on a press and processed on-press by rotating said plate cylinder while feeding dampening liquid and/or ink to the coating of the precursor to remove the unexposed areas from the support. In a preferred embodiment, only dampening liquid is supplied to the plate during start-up of the press. After a number of revolutions of the plate cylinder, preferably less than 50 and most preferably less than 5 revolutions, also the ink supply is switched on. In an alternative embodiment, supply of dampening liquid and ink can be started simultaneously or only ink can be supplied during a number of revolutions before switching on the supply of dampening liquid.

The processing step may also be performed by combining embodiments described above, e.g. combining development with a processing liquid with development on-press by applying ink and/or fountain.

### Processing Liquid

The processing liquid may be an alkaline developer or solvent-based developer. Suitable alkaline developers have been described in US2005/0162505. An alkaline developer is an aqueous solution which has a pH of at least 11, more typically at least 12, preferably from 12 to 14. Alkaline developers typically contain alkaline agents to obtain high pH values can be inorganic or organic alkaline agents. The developers can comprise anionic, non-ionic and amphoteric surfactants (up to 3% on the total composition weight); biocides (antimicrobial and/or antifungal agents), antifoaming agents or chelating agents (such as alkali gluconates), and thickening agents (water soluble or water dispersible polyhydroxy compounds such as glycerine or polyethylene glycol).

Preferably, the processing liquid is a gum solution whereby during the development step the non-exposed areas of the photopolymerisable layer are removed from the support and the plate is gummed in a single step. The development with a gum solution has the additional benefit that, due to the remaining gum on the plate in the non-exposed areas, an additional gumming step is not required to protect the surface of the support in the non-printing areas. As a result, the precursor is processed and gummed in one single step which involves a less complex developing apparatus than a developing apparatus comprising a developer tank, a rinsing section and a gumming section. The gumming section may comprise at least one gumming unit or may comprise two or more gumming units. These gumming units may have the configuration of a cascade system, i.e. the gum solution, used in the second gumming unit and present in the second tank, overflows from the second tank to the first tank when gum replenishing solution is added in the second gumming unit or when the gum solution in the second gumming unit is used once-only, i.e. only starting gum solution is used to develop the precursor in this second gumming unit by preferably a spraying or jetting technique. More details concerning such gum development is described in EP1 788 444.

A gum solution is typically an aqueous liquid which comprises one or more surface protective compounds that are capable of protecting the lithographic image of a printing plate against contamination, e.g. by oxidation, fingerprints, fats, oils or dust, or damaging, e.g. by scratches during handling of the plate. Suitable examples of such surface protective compounds are film-forming hydrophilic polymers or surfactants. The layer that remains on the plate after treatment with the gum solution preferably comprises between 0.005 and 20 g/m² of the surface protective compound, more preferably between 0.010 and 10 g/m², most preferably between 0.020 and 5 g/m². More details concerning the surface protective compounds in the gum solution can be found in WO 2007/057348 page 9 line 3 to page 11 line 6. As the developed plate precursor is developed and gummed in one step, there is no need to post-treat the processed plate.

The gum solution preferably has a pH value between 3 and 11, more preferably between 4 and 10, even more preferably between 5 and 9, and most preferably between 6 and 8. A suitable gum solution is described in for example EP 1 342 568 in [0008] to [0022] and WO2005/111727. The gum solution may further comprise an inorganic salt, an anionic surfactant, a wetting agent, a chelate compound, an antiseptic compound, an antifoaming compound and/or an ink receptivity agent and/or combinations thereof. More details about these additional ingredients are described in WO 2007/057348 page 11 line 22 to page 14 line 19.

### Drying and Baking Step

After the processing step the plate may be dried in a drying unit. In a preferred embodiment the plate is dried by heating the plate in the drying unit which may contain at least one heating element selected from an IR-lamp, an UV-lamp, a heated metal roller or heated air.

After drying the plate can optionally be heated in a baking unit. More details concerning the heating in a baking unit can be found in WO 2007/057348 page 44 line 26 to page 45 line 20.

The printing plate thus obtained can be used for conventional, so-called wet offset printing, in which ink and an aqueous dampening liquid is supplied to the plate. Another suitable printing method uses a so-called single-fluid ink without a dampening liquid. Suitable single-fluid inks have been described in U.S. Pat. Nos. 4,045,232; 4,981,517 and 6,140,392. In a most preferred embodiment, the single-fluid ink comprises an ink phase, also called the hydrophobic or oleophilic phase, and a polyol phase as described in WO 00/32705.

### EXAMPLES

### 1. Preparation of the Printing Plate Precursors Preparation of the Aluminium Support S-01

A 0.3 mm thick aluminium foil was degreased by spraying with an aqueous solution containing 26 g/l NaOH at 65° C. for 2 seconds and rinsed with demineralised water for 1.5 seconds. The foil was then electrochemically grained during 10 seconds using an alternating current in an aqueous solution containing 15 g/l HCl, 15 g/l SO₄²⁻ ions and 5 g/l Al³⁺ ions at a temperature of 37° C. and a current density of about 100 A/dm². Afterwards, the aluminium foil was then desmutted by etching with an aqueous solution containing 5.5 g/l of NaOH at 36° C. for 2 seconds and rinsed with demineralised water for 2 seconds. The foil was subsequently subjected to anodic oxidation during 15 seconds in an aqueous solution containing 145 g/l of sulfuric acid at a temperature of 50° C. and a current density of 17 A/dm², then washed with demineralised water for 11 seconds and dried at 120° C. for 5 seconds.

The support thus obtained was characterized by a surface roughness Ra of 0.35-0.4 μm (measured with interferometer NT1100) and had an oxide weight of 3.0 g/m².

### Preparation of Inventive Printing Plates PP-01, PP-02, PP-05 and PP-06 and Comparative Printing Plates PP-03, PP-04, PP-07 and PP-08.

### Photopolymerisable Layer

The printing plate precursor PPP-01 to PPP-08 were prepared by coating onto the above described support S-01 the components as defined in Table 1 dissolved in a mixture of 35% by volume of MEK and 65% by volume of Dowanol PM (1-methoxy-2-propanol, commercially available from DOW CHEMICAL Company). The coating solution was applied at a wet coating thickness of 30 μm and then dried at 120° C. for 1 minute in a circulation oven.

TABLE 1
Printing plate precursors PPP-01 to PPP-09

| INGR. | PPP-01 | PPP-02 | PPP-03 | PPP-04 | PPP-05 | PPP-06 | PPP-07 | PPP-08 |
|---|---|---|---|---|---|---|---|---|
| g/m² | inv | inv | comp | comp | inv | inv | comp | comp |
| IR-01 (1) | 0.022 | 0.022 | 0.022 | 0.022 | 0.024 | 0.020 | 0.020 | — |
| IR-02 (1) | — | — | — | 0.094 | — | — | — | — |
| IR-03 (1) | — | — | — | — | — | — | — | 0.020 |
| Binder-01 | 0.227 | — | — | — | — | — | — | — |
| (2) | | | | | | | | |
| Binder-02 | — | 0.200 | 0.200 | 0.200 | — | — | — | — |
| (3) | | | | | | | | |
| Binder-03 | — | — | — | — | — | 0.200 | 0.200 | 0.200 |
| (4) | | | | | | | | |
| Binder-04 | — | — | — | — | 0.150 | — | — | — |
| (5) | | | | | | | | |
| FST 510 | 0.245 | — | — | — | 0.310 | 0.233 | 0.233 | 0.233 |
| (6) | | | | | | | | |
| CN-UVE | 0.354 | — | — | — | 0.310 | 0.290 | 0.290 | 0.290 |
| 151M (7) | | | | | | | | |
| Mono Z1620 | — | 0.150 | 0.150 | 0.150 | — | — | — | — |
| (8) | | | | | | | | |
| Ebecryl | — | 0.400 | 0.400 | 0.400 | — | — | — | — |
| 220 (9) | | | | | | | | |
| Tegoglide | 0.0015 | 0.0015 | 0.0015 | 0.0015 | 0.0015 | 0.0015 | 0.0015 | 0.0015 |
| 410 (10) | | | | | | | | |
| Initiator- | 0.064 | 0.060 | — | — | 0.066 | 0.063 | — | — |
| 01 (11) | | | | | | | | |
| Initiator- | — | — | 0.060 | 0.060 | — | — | 0.063 | 0.063 |
| 02 (12) | | | | | | | | |
| Sipomer | 0.127 | 0.130 | 0.130 | 0.130 | 0.143 | 0.130 | 0.130 | 0.130 |
| PAM 100 | | | | | | | | |
| (13) | | | | | | | | |
| Albritect | — | 0.024 | 0.024 | 0.024 | 0.026 | — | — | — |
| CP 30 (14) | | | | | | | | |
| Dry | 1.041 | 0.964 | 0.964 | 1.058 | 1.096 | 0.968 | 0.968 | 0.968 |
| coating | | | | | | | | |
| weight | | | | | | | | |
| (g/m2) | | | | | | | | |

1) IR-01 is an infrared absorbing dye commercially available from FEW Chemicals as S2025 having the following structure: 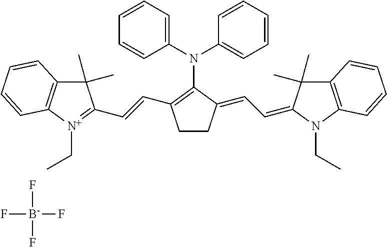 [SMILES: CCN1/C(=C/C=C2\CCC(/C=C/C3=[N+](CC)c4ccccc4C3(C)C)=C2N(c2ccccc2)c2ccccc2)C(C)(C)c2ccccc21 ; F[B-](F)(F)F]
IR-02 is an infrared absorbing dye synthesized as described in the Examples of EP 2 234 964 having the following structure: 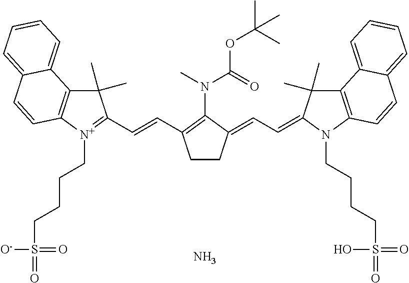
IR-03 is an infrared absorbing dye commercially available form FEW Chemicals as S0507 having the following structure: 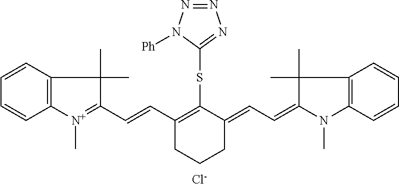 [SMILES: CN1/C(=C/C=C2\CCCC(/C=C/C3=[N+](C)c4ccccc4C3(C)C)=C2Sc2nnnn2-c2ccccc2)C(C)(C)c2ccccc21 ; [Cl-]]
2) Binder-01 represents KL7177, a methyl methacrylate copolymer with methacrylic acid, commercially available from AZ Electronics;
3) Binder-02 represents Alberdingk U180, an aliphatic polyester polyurethane commercially available as a 50 wt. % aqueous dispersion commercially available from Alberdingk Boley;
4) Binder-03 represents Ruco Coat EC4811, an aliphatic polyether polyurethane commercially available as a 30 wt. % aqueous dispersion from Rudolf GmbH;
5) Binder-04 represents S-LEC BX35-Z, a polyvinylbutyral commercially available from Sekisui;
6) FST 510 is a reaction product from 1 mole of 2,2,4-trimethyl-hexamethylenediisocyanate and 2 moles of hydroxyethyl-methacrylate commercially available from AZ Electronics as a 82 wt. % solution in MEK;
7) CN-UVE 151M is an epoxy diacrylate monomer commercially available from Sartomer;
8) Mono Z1620 is a solution in MEK containing 30 wt % of a reaction product from 1 mole of 2-hydroxyethylmethacrylate and 0.5 mole of 2-(2-hydroxyethyl-piperidine);
9) Ebecryl 220 is a hexafunctional aromatic urethane acrylate commercially available from Allnex;
10) Tegoglide 410 is a surfactant commercially available from Evonik Tego Chemie GmbH;
11) p-OH-TBMPS is 4-hydroxyphenyl-tribromomethyl-sulfone
12) Bis(4-tert-butyl phenyl) iodonium tetraphenylborate is an onium initiator commercially available from AZ electronics.;
13) Sipomer PAM 100 is a methacrylate phosphonic ester commercially available from Rhodia;
14) Albritect CP 30, is a copolymer of vinylphosphonic acid and acrylic acid commercially available as a 20 wt % aqueous dispersion from Rhodia.

### Protective Top Layer

On top of the photosensitive layer, a solution in water with the composition as defined in Table 2 was coated (40 μm) on the printing plate precursors, and dried at 110° C. for 2 minutes. The so-formed protective top layer OC-1 has a dry thickness or dry coating weight of 1.25 g/m².

TABLE 2
composition of the overcoat

| INGREDIENT g | OC-01 |
|---|---|
| Mowiol 4-88 (1) | 19.1 |
| Mowiol 8-88 (1) | 5.84 |
| Luviskol K30 (2) | 5.95 |
| Acticide LA1206 (3) | 0.06 |
| Lutensol A8 (4) | 0.30 |
| Water | 969 |

1) Mowiol 4-88TM and Mowiol 8-88TM are partially hydrolyzed polyvinylalcohols commercially available from Kuraray;
2) Luviskol K30TM is polyvinylpyrrolidone homopolymer commercially available from BASF;
3) Acticide LA1206TM is a biocide commercially available from Thor;
4) Lutensol ASTM is a surface active agent commercially available from BASF.

### 2. Imaging

The printing plate precursors were subsequently imaged at 2400 dpi with a High Power Creo 40W TE38 thermal platesetter (200 lpi Agfa Balanced Screening (ABS)), commercially available from Kodak and equipped with a 830 nm IR laser diode, at energy densities between 70 and 250 mJ/cm².

### ΔE Measurement

Lab measurement executed with a GretagMacBeth SpectroEye reflection spectrophotometer with the settings: D50 (illuminant), 2° (Observer), No filter; commercially available from GretagMacBeth. The total colour difference ΔE is a single value that takes into account the difference between the L, a* and b* values of the image areas and the non-image areas:

ΔE=\sqrt{ΔL²+Δa²+Δb²}

The higher the total colour difference ΔE, the better the obtained contrast. The contrast between image and non-image areas results in the occurrence of a print-out image.

### Example 1: The Effect of Exposure Energy on the Obtained Contrast

### 1. Inventive Printing Plate Precursor PPP-01

A solid pattern was imaged on PPP-01, inventive printing plate precursor, at different energy settings. The L*a*b* values of both the non-image areas and the solid imaged area were measured and the respective delta E (ΔE) values were calculated. Table 3 summarizes the obtained results.

TABLE 3
Effect of exposure energy on the obtained contrast
(PPP-01)

| Exposure | | | | |
|---|---|---|---|---|
| energy | PPP-01 (INV) | | | |
| mJ/cm² | ΔL | Δa* | Δb* | ΔE (1) |
| Non-image area | 68.96 | −2.56 | −4.15 | — |
| 80 | 68.57 | −6.48 | −5.97 | 4.34 |
| 100 | 68.12 | −7.3 | −6 | 5.16 |
| 120 | 65.86 | −8.19 | −6.04 | 6.70 |
| 130 | 65.64 | −8.58 | −6.03 | 7.13 |
| 150 | 65.41 | −9.34 | −6.03 | 7.88 |
| 200 | 65.21 | 11.34 | −6.11 | 9.75 |
| 250 | 65.08 | 12.36 | −5.99 | 10.70 |

(1) A good contrast is defined as ΔE ≥ 3.0.
2. Printing plate precursors PPP-02 (inventive) and PPP-03
(comparative)

A solid pattern was imaged on the inventive printing plate precursor PPP-02 and comparative printing plate precursor PPP-03 at different energy settings. Based on the L*a*b* values of both the non-image areas and the solid imaged areas the respective delta E (ΔE) values were calculated. Table 4 summarizes the obtained results.

TABLE 4
Effect of exposure energy on the obtained contrast

| Exposure | | |
|---|---|---|
| energy | ΔE (1) | |
| mJ/cm² | PPP-02 | PPP-03 |
| 80 | 3.08 | 1.5 |
| 100 | 3.77 | 1.58 |
| 120 | 3.92 | 2.12 |
| 130 | 4.47 | 2.4 |
| 150 | 5.68 | 2.94 |
| 200 | 8.21 | 3.99 |
| 250 | 9.70 | 4.6 |

(1) a good contrast is defined as ΔE ≥ 3.0.

The obtained results in Tables 3 and 4 indicate that
the inventive printing plate precursors PPP-01 and PPP-02 including the TBM-initiator without the presence of a colorant result in a good image contrast already at low energy settings, i.e. at 80 mJ/cm²;
comparative printing plate precursors PPP-03 only shows a good image contrast at 200 mJ/cm²;
the higher the exposure energy, the better the obtained contrast.

### Example 3: Effect of the Initiator

A solid pattern was imaged on the printing plate precursors PPP-01 to PPP-07 at 120 mJ/m². The L*a*b* values of both the non-image areas and the solid imaged areas were measured and the respective delta E (ΔE) values were calculated. Table 5 summarizes the obtained results.

TABLE 5
effect of type of initiator on the obtained contrast

| Exposure energy at | |
|---|---|
| 120 mJ/cm² | ΔE (1) |
| PPP-01 | 6.7 |
| inventive | |
| PPP-02 | 3.92 |
| inventive | |
| PPP-03 | 2.12 |
| comparative | |
| PPP-04 | 2.99 |
| comparative | |
| PPP-05 | 5.75 |
| inventive | |
| PPP-06 | 4.25 |
| inventive | |
| PPP-07 | 2.45 |
| comparative | |

(1) a good contrast is defined as ΔE ≥ 3.0.

The results in Table 5 show that the inventive printing plate precursors PPP-01, PPP-02, PPP-5 and PPP-06 including the TBM-initiator in combination with the infrared absorbing compound result in a good contrast in terms of delta E (ΔE) values after imaging, while the comparative printing plate precursors PP-03, PP-04 and PP-07 including an onium based initiator, result in a poor visual contrast. The comparative sample PP-04 includes a high concentration of infrared dyes (IR-01 and IR-02).

### Example 4: Effect of the Exposure Energy/Initiator

A solid pattern was imaged on the printing plate precursors at respectively 80 mJ/m² and 120 mJ/m². The L*a*b* values of both the non-image areas and the solid imaged areas were measured and the respective delta E (ΔE) values were calculated. Table 6 summarizes the obtained delta E (ΔE) results.

TABLE 6
Effect of the exposure energy/initiator

| | Exposure energy | |
|---|---|---|
| | mJ/cm² | |
| ΔE (1) | 80 | 120 |
| PPP-01 | 4.34 | 6.7 |
| inventive | | |
| PPP-02 | 3.08 | 3.92 |
| inventive | | |
| PPP-03 | 1.5 | 2.12 |
| comparative | | |
| PPP-04 | 1.73 | 2.56 |
| comparative | | |
| PPP-05 | 4.02 | 5.75 |
| inventive | | |
| PPP-06 | nd (2) | 4.25 |
| inventive | | |
| PPP-07 | nd (2) | 2.45 |
| comparative | | |
| PPP-08 | nd (2) | 1.45 |
| comparative | | |

(1) a good contrast is defined as ΔE ≥ 3.0;
(2) nd = not determined

The results show that even at the low exposure energy 80 mJ/m² a good visual contrast ΔE≥3 is obtained for the inventive printing plate precursors while for the comparative printing plate precursors a poor visual contrast is obtained at both 80 mJ/m² and 120 mJ/m².

1-15. (canceled)

16. A lithographic printing plate precursor comprising:
a support;
a coating provided on the support and including a polymerizable compound, an infrared absorbing dye, and a photoinitiator; wherein
the infrared absorbing dye and the photoinitiator are able to induce a print-out image and the coating does not substantially include a colorant having an absorption maximum below 780 nm.

17. The printing plate precursor according to claim 16, wherein the coating does not substantially include a colorant having an absorption maximum between 390 nm and 750 nm.

18. The printing plate precursor according to claim 16, wherein the photoinitiator includes an optionally substituted trihaloalkyl sulfone compound.

19. The printing plate precursor according to claim 16, wherein the photoinitiator includes an optionally substituted tribromomethyl aryl sulfone.

20. The printing plate precursor according to claim 16, wherein the infrared absorbing agent is present in an amount between 0.1 wt % and 3 wt % based on a total dry weight of the coating.

21. The printing plate precursor according to claim 16, wherein the infrared absorbing agent includes a heptamethinecyanine dye.

22. The printing plate precursor according to claim 16, wherein the infrared absorbing agent is represented by Formula I: 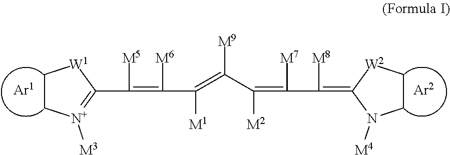
wherein
Ar¹ and Ar² are independently an optionally substituted aryl group or an aryl group with an annulated benzene ring that is optionally substituted;
W¹ and W² are independently a sulphur atom or a —CM¹⁰M¹¹ group in which M10 and M¹¹ are independently an optionally substituted aliphatic hydrocarbon group or an optionally substituted (hetero)aryl group, or in which M¹⁰ and M¹¹ together include atoms necessary to form a cyclic structure;
M¹ and M² together include atoms necessary to form an optionally substituted cyclic structure;
M³ and M⁴ independently represent an optionally substituted aliphatic hydrocarbon group;
M⁵, M⁶, M⁷, and M⁸ independently represent hydrogen, a halogen, or an optionally substituted aliphatic hydrocarbon group;
M⁹ represents a halogen, an optionally substituted aliphatic hydrocarbon group, an optionally substituted (hetero)aryl group, —NR¹R², —NR¹—CO—R⁶, —NR¹—SO₂—R⁴, or —NR¹—SO—R⁵;
R¹ and R² independently represent hydrogen, an optionally substituted aliphatic hydrocarbon group, or an optionally substituted (hetero)aryl group;
R⁴ and R⁶ independently represent —OR⁷, —NR⁸R⁹, or —CF₃ in which R⁷ represents an optionally substituted (hetero)aryl group or an optionally branched aliphatic hydrocarbon group, and R⁸ and R⁹ independently represent hydrogen, an optionally substituted aliphatic hydrocarbon group, or an optionally substituted (hetero)aryl group, or in which R⁸ and R⁹ together include atoms necessary to form a cyclic structure;
R⁵ represents hydrogen, an optionally substituted aliphatic hydrocarbon group, SO₃⁻, —COOR¹⁰, or an optionally substituted (hetero)aryl group;
R¹⁰ represents an optionally substituted (hetero)aryl group or an aliphatic hydrocarbon group; and
the infrared absorbing agent may include one or more counter ions in order to obtain an electrically neutral molecule.

23. The printing plate precursor according to claim 22, wherein M¹ and M² together include atoms necessary to form an optionally substituted 5-membered ring.

24. The printing plate precursor according to claim 22, wherein
M⁹ represents —NR¹R² or —NR¹—CO—R⁶;
R¹ and R² independently represent hydrogen, an optionally substituted aliphatic hydrocarbon group, or an optionally substituted (hetero)aryl group;
R⁶ represents —OR⁷, —NR⁸R⁹, or —CF₃ in which R⁷ represents an optionally substituted (hetero)aryl group or an optionally branched aliphatic hydrocarbon group; and R⁸ and R⁹ independently represent hydrogen, an optionally substituted aliphatic hydrocarbon group, or an optionally substituted (hetero)aryl group, or in which R⁸ and R⁹ together include atoms necessary to form a cyclic structure.

25. The printing plate precursor according to claim 22, wherein the infrared absorbing agent is represented by Formula II, III, or IV: 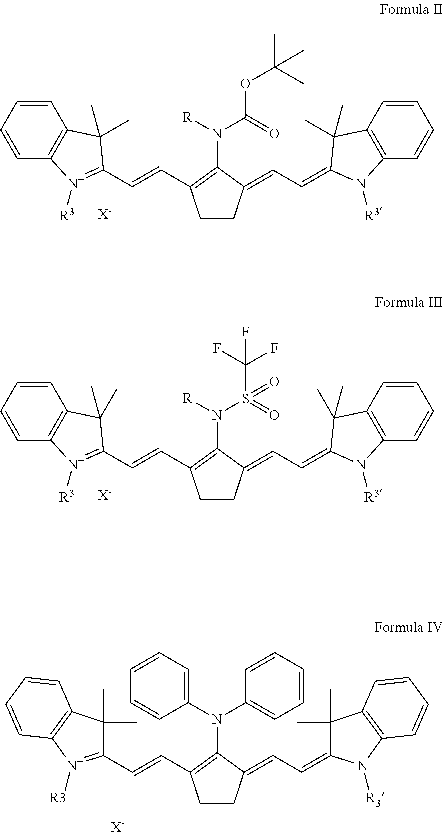
wherein
X⁻ represents halogen, sulphonate, perfluorosulphonate, tosylate, tetrafluoroborate, hexafluorophosphate, arylborate, or arylsulphonate; and
R³ and R^{3′} independently represent an optionally substituted alkyl group or an ether group.

26. A method for making a printing plate comprising:
image-wise exposing the printing plate precursor as defined in claim 16 to heat and/or IR radiation to produce a lithographic image including image areas and non-image areas, and to induce a color change in the image areas; and
developing the image-wise exposed printing plate precursor.

27. The method according to claim 26, wherein the step of developing the image-wise exposed printing plate precursor includes:
mounting the printing plate precursor on a plate cylinder of a lithographic printing press and rotating the plate cylinder while feeding dampening liquid and/or ink to the printing plate precursor.

28. The method according to claim 26, wherein the color change is characterized by a CIE 1976 color distance ΔE between the image areas and the non-image areas of at least 3.

29. The method according to claim 26, wherein an energy density of the IR radiation is between 70 mJ/m² and 150 mJ/m².

30. The method according to claim 26, wherein an energy density of the IR radiation is between 75 mJ/m² and 120 mJ/m².
